(19) United States
(12) Patent Application Publication
(10) Pub. No.: US 2012/0166350 A1
(43) Pub. Date: Jun. 28, 2012

(54) Remote dating method

(76) Inventors: Gregory A. Piccionelli, Westlake Village, CA (US); Michael M. Gerardi, Menifee, CA (US)

(21) Appl. No.: 13/317,622

(22) Filed: Oct. 24, 2011

Related U.S. Application Data
(63) Continuation-in-part of application No. 11/998,679, filed on Nov. 30, 2007, now abandoned.
Application No. 11/998,679 is a continuation of application No. 10/460,105, filed on Jun. 11, 2003, now abandoned.
Application No. 10/460,105 is a continuation-in-part of application No. 12/070,715, filed on Feb. 20, 2008, now abandoned.
(60) Provisional application No. 60/388,381, filed on Jun. 12, 2002.
(60) Provisional application No. 60/902,771, filed on Feb. 21, 2007.

(51) Int. Cl. G06Q 99/00

(52) U.S. Cl. 705/319

(57) ABSTRACT

A method of establishing personal contact between an inquiring individual and a target individual, the inquiring and target individuals being members of an organization, includes the steps of identifying a target individual of interest to an inquiring individual, determining the location of the target individual and providing the location of the target individual to a central location, providing the target individual with a message that the inquiring individual is interested in establishing personal contact with the target individual, and providing the inquiring individual with authorization to establish personal contact with the target individual when the target individual provides a positive response to the central location.

This application is a continuation-in-part of U.S. patent application Ser. No. 11/998,679, filed Nov. 30, 2007, which in turn is a continuation of U.S. patent application Ser. No. 10/460,105, filed Jun. 11, 2003, which in turn is based on U.S. Provisional Patent Application Ser. No. 60/388,381, filed Jun. 12, 2002. This application is also a continuation-in-part of U.S. patent application Ser. No. 12/070,715, in the name of Gregory A. Piccionelli and Michael M. Gerardi, entitled “Co-ordinated On-line Video Viewing”, filed Feb. 20, 2008, which in turn is based on U.S. Provisional Patent Application Ser. No. 60/902,771, filed Feb. 21, 2007. The disclosures of each of the foregoing patent applications are incorporated in their entirety herein by this reference.

### FIELD OF THE INVENTION

The present invention relates to a method system and apparatus for enabling an inquiring individual to contact a target individual and for the target individual to authorize such contact.

### BACKGROUND OF THE INVENTION

In modern society, in particular in large urban areas, it is often difficult for individuals to make social contacts with other individuals of interest. Organized activities such as service organizations, church groups and the like are not always available to all individuals or in many areas. Traditional venues for social interaction, such as bars, nightclubs and the like, often prove unsatisfactory, as do conventional dating services.

Recent developments in telecommunications and data processing, and in particular the development of broadband capability in connection with wide-area networks such as the Internet, offer the potential for facilitating the transmission and reception of large amounts of information between individuals who may be interested in meeting each other. However, at present such interactions are typically confined to inquiring individuals operating from fixed locations, such as home or office computers.

A need exists for a method of enabling individuals to make social, contact with each other. More specifically, a need exists for a method enabling individuals in social settings, such as nightclubs, bars, restaurants and the like, to transmit and receive information concerning each other in order to assist in deciding whether to proceed with personal contact, and to facilitate establishment of personal contact.

A need also exists for a system and apparatus facilitating such methods.

### SUMMARY OF THE PREFERRED EMBODIMENTS

In accordance with one aspect of the present invention, there is provided a method of establishing personal contact between an inquiring individual and a target individual, the inquiring and target individuals being members of an organization. The method includes the steps of identifying a target individual of interest to an inquiring individual, determining the location of the target individual and providing the location of the target individual to a central location, providing the target individual with a message that the inquiring individual is interested in establishing personal contact with the target individual, and providing the inquiring individual with authorization to establish personal contact with the target individual when the target individual provides a positive response to the central location.

In particular embodiments, the inquiring and target individuals further interact by simultaneous on-line viewing of at least a portion of an on-line video file.

In accordance with another aspect of the present invention, there is provided a device for facilitating the establishment of personal contact between an inquiring individual and a target individual. The device includes ranging means for determining the distance between a target individual and an inquiring individual, means for determining the location of a target individual, and means for transmitting information to a central location and receiving information from the central location.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which

FIG. 1 is a flowchart illustrating an example of a method of the invention by which an inquiring individual identifies, locates and establishes contact with a target individual,

FIGS. 2A-C are a schematic diagram, side view and top view, respectively, illustrating an exemplary system for implementing a method of the invention, including a headset and an integrated processing/transceiving unit,

FIG. 3 is a top view of an alternative headset that employs an infrared pointer device,

FIG. 4 is an illustration of implementation of a method according to the invention in which an inquiring individual attempts to establish contact with a target individual,

FIG. 5 is an illustration of a display of information pertaining to a target individual, which is provided to an inquiring individual, and

FIG. 6 is a flowchart illustrating a co-ordinated on-line viewing method used in particular embodiments of methods according to the invention in which an inquiring individual and a target individual agree to watch an on-line video file together.

Like numerals refer to like parts throughout the several views of the drawings.

### DETAILED DESCRIPTION OF THE PREFERRED EMBODIMENTS

Target Identification

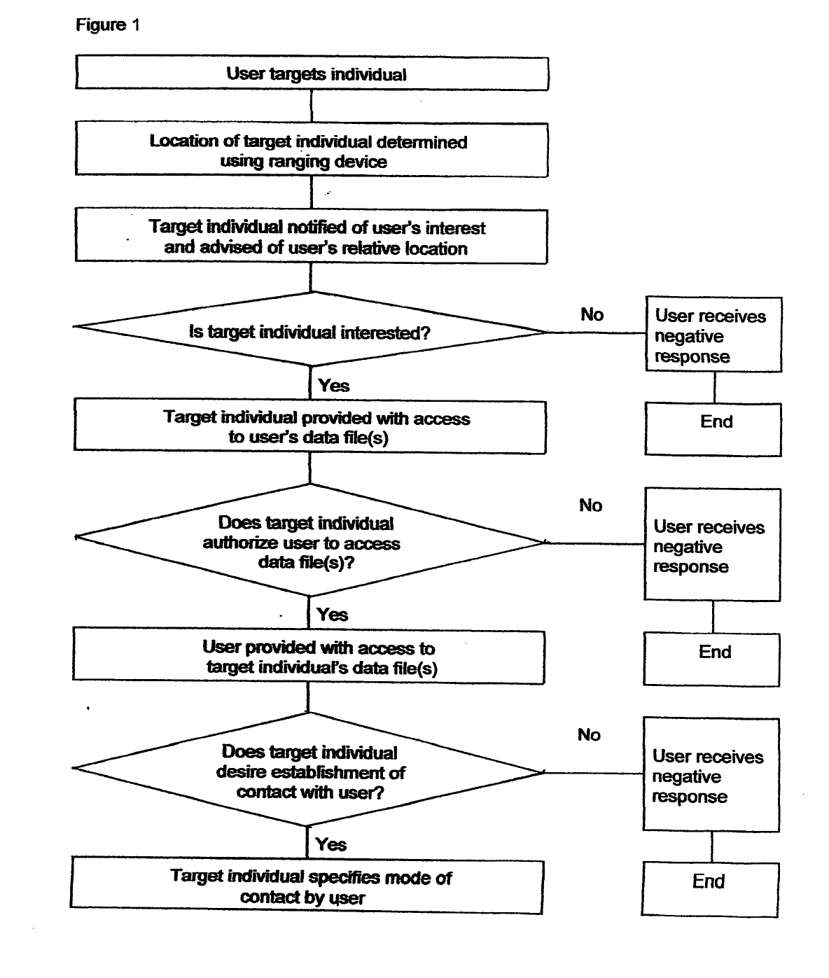

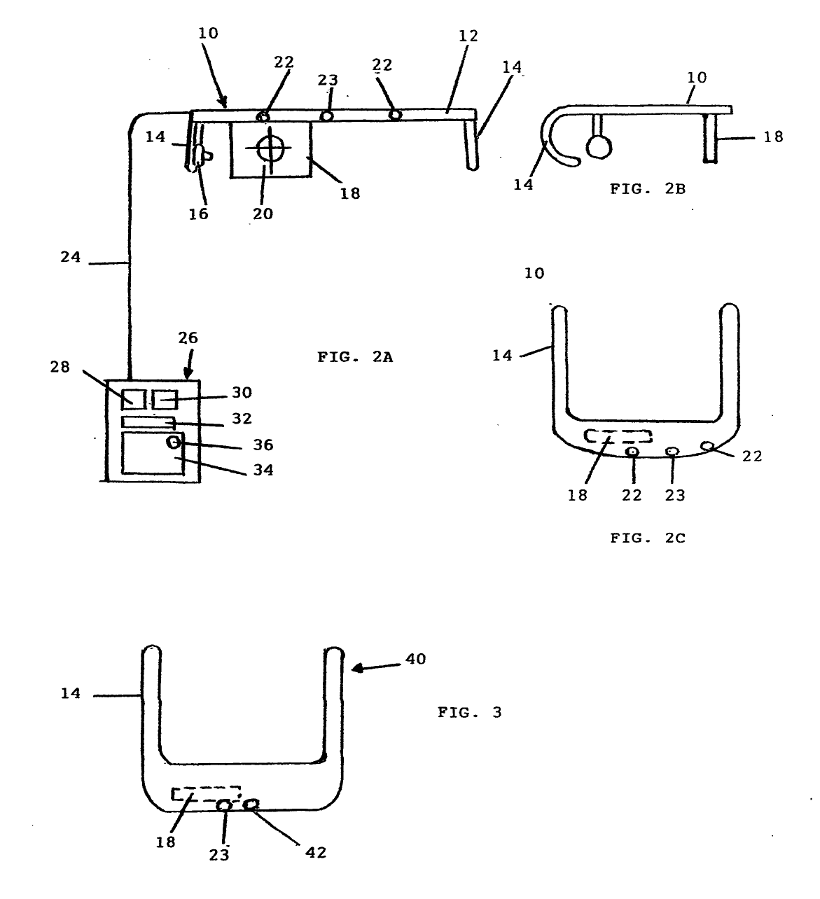

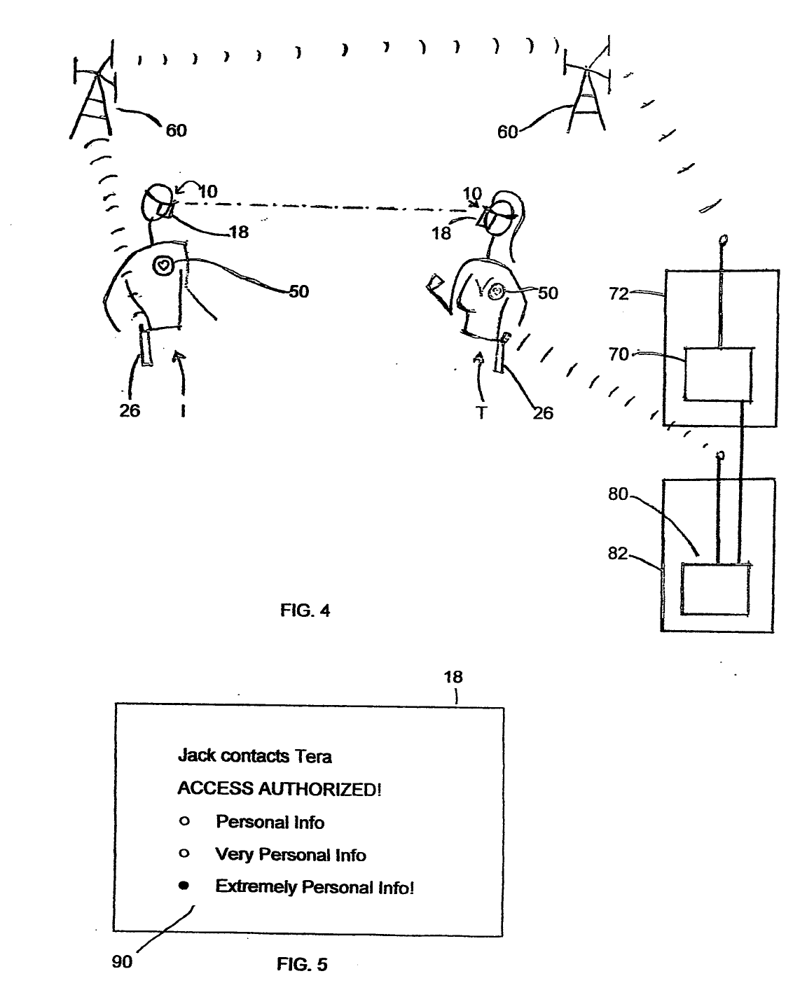

Turning now to the embodiment illustrated in FIGS. 1, 2A-C and 4, an inquiring individual “I” (generally, a “user”) first targets an individual of interest. Preferably, the target individual “T” is visually identifiable as a member of a remote dating organization, and more preferably as a member of a remote dating organization to which the inquiring individual belongs or which is affiliated with the inquiring individual's organization. Such visual identification can be accomplished, for example, by the target individual's use of a membership device such as a device 10 with a heads-up display (HUD) 18, an LED, a badge 50, or another visual indicator. Very preferably, the target individual also is equipped with a transmitter, an Internet connection or the like, (e.g., integrating processing/transceiving unit 26, as discussed further below), that provides the target individuals location (e.g., GPS coordinates) to a central location maintained by the remote dating organization to which the target individual belongs. In preferred embodiments, the target individual's location is periodically or continually updated in order to account for movement by the target individual.

Next, the inquiring individual determines the location of the target individual, more particularly the location of the target individual relative to the inquiring individual's location. The distance between the inquiring individual and the target individual is determined using a ranging device. Appropriate ranging devices include, without limitation, a device having an element that determines the range to a target based on the eye positions of the inquiring individual (e.g., using a cross-hairs element); an infrared pointer device; an ultrasonic device, or any other ranging device. See, e.g., cross-hairs element 20 and sensors 22 of headset 10 of FIGS. 2A-C, discussed below.

Preferably, the inquiring individual also carries an element, such as a GPS locator, that provides the inquiring individual's location, as well as the orientation of the inquiring individual (i.e., the direction in which the inquiring individual is facing). The inquiring individual's location and orientation, together with the location of the target individual relative to the inquiring individual, thus can be used to determine the location of the target individual.

Once the location of the target individual has been determined, this location is transmitted to a central location 70, in particular to a central computer operated by the remote dating service 72 to which the inquiring individual belongs. In particular embodiments, the information is transmitted via wide-area network 60, such a the Internet, using a device carried by the inquiring individual, such as unit 26 of FIG. 2A, a personal data manager, a cellular telephone having Internet accessibility, etc. Alternatively, the information can be transmitted by other means such as telephonically (e.g., by the inquiring individual accessing an appropriate telephone number of the remote dating service and providing the GPS coordinates of the target individual verbally or by using the telephone's keys).

Target Contact

When the central location is provided with the location of the target individual, the central location 70 contacts the target individual, either directly or via a second central location 80 maintained by an affiliated remote dating organization 82 to which the target individual belongs. In particular embodiments, the central location correlates the location information provided by the target individual, as discussed above, with the location information provided by the inquiring individual, in order to identify and then contact the correct target individual.

Contact with the target individual can be effected in various ways. In particular embodiments, the target individual is contacted via a device including a heads-up display (HUD) 18 and optionally an earphone 16, worn by the target individual (see FIG. 2A); telephonically, for example, via a cellular telephone; via a wide-area network accessible by the target individual by use of a personal data manager; or by any other communication device.

Upon contact, the target individual is notified that the inquiring individual is interested in contacting her/him. In particular embodiments, the target individual is first advised that someone, not further identified, is interested in making contact. The target individual is then given the option of receiving more information concerning the person expressing interest (i.e., the inquiring individual) at which point the target individual is notified of the location of the inquiring individual. The target individual can then look toward the inquiring individual's location and visually identify the inquiring individual before deciding whether or not to receive further information and/or establish contact. In other particular embodiments, the target individual is provided with the inquiring individual's location immediately.

Having been provided with the inquiring individual's location, the target individual is then afforded the option of receiving further information concerning the inquiring individual. If the target individual is not interested, the target individual can provide a negative response to the central location by any desired means (e.g., telephonically, via an HUD, via a hand-held unit with access to a wide-area network such as the Internet, and the like), which the central location then relays to the inquiring individual. Alternatively, the target individual can simply elect not to respond. After a predetermined time, this lack of response constitutes a negative response by default, and the negative response again is relayed by the central location to the inquiring individual.

Positive Response by Target

On the other hand, if the target individual desires to receive further information concerning the inquiring individual, the target individual provides a positive response to the central location. The central location then provides the target individual with additional information about the inquiring individual. In particular embodiments, the central location provides to the target individual a menu 90 (see FIG. 5) listing one or more data files containing information about the inquiring individual. Such files can include, without limitation, text files including the inquiring individual's biographical information, including professional information, awards received, etc.; files containing photographic images of the inquiring individual, the inquiring individual's residence, personal vehicle(s), boats and the like, art works created by the inquiring individual, etc.; audio files including readings by the inquiring individual, musical works, and the like; video files featuring the inquiring individual, news articles; and any other digital data file, data stream, and the like. The inquiring individual then selects one or more data files of interest from the menu.

The data files containing information about the inquiring individual can be accessed by the target individual using various devices. In particular embodiments, the target individual accesses the data files using a device for accessing the Internet or other wide-area network, together with an HUD on which the information in the files is displayed and, in more particular embodiments, an earphone or other device for conveying audio information.

After accessing one or more data files containing information about the inquiring individual, the target individual is then afforded the choice of whether to allow the inquiring individual to access one or more data files containing information about the target individual. If the target individual chooses to deny access to the inquiring individual, or defaults by not making a choice within a predetermined time period, a negative response is provided to the central location and thence to the inquiring individual. If, on the other hand, the target individual finds the inquiring individual of interest and wishes to grant access to the target individual's data file(s), the target individual provides a positive response to the central location. The central location then provides the inquiring individual with access to one or more of the target individual's data file(s) The inquiring individual then accesses the target individual's data file(s) in particular embodiments in a manner similar to that described above.

In more specific embodiments, the target individual specifies the level of disclosure depending on various circumstances, such as age, desired degree of intimacy with the inquiring individual, previous acquaintance with the inquiring individual, etc. Thus, the target individual could specify that files containing basic information, such as age, educational background, interests, etc. are to be made accessible to inquiring individuals with whom the target individual is not already familiar, while files containing more intimate information, such as photographs, favorite activities, etc. are to be made accessible to inquiring individuals with whom the target Individual is already familiar or with whom the target individual desires a more intimate relationship. For example, assuming that the target individual has previously classified his/her data files into three levels of disclosure, the target individual could provide a response to the central location granting the inquiring individual access only to those files classified as level 1. If the target individual fines the inquiring individual more desirable or wishes to allow greater access to his/her files, the target individual could provide a response to the central location granting the inquiring individual access to level 2 or level 3 files. Preferably, higher level access also allows the inquiring individual to access lower level files as well.

Initiation of Contact

Having authorized the inquiring individual to access his/her data file(s), the target individual is then afforded the option of authorizing personal contact by the inquiring individual. At this point, the target individual can still change his/her mind and provide the central location with a negative response, or can default by not providing any response; in either event, the central location then provides a negative response to the inquiring individual. Alternatively the target individual can provide a positive response to the central location authorizing the inquiring individual to establish personal contact with the target individual. In particular embodiments, the target individual is given the option of specifying the mode of contact. For example, the target individual is provided with a menu including telephonic or e-mail contact, personal contact at the present time, personal contact at a later time and/or at a different location (specifiable by the target individual, for example by typing in the appropriate time and/or location using a keyword or other input device), and the like.

In one particular example, the target individual provides the central location with a response authorizing the inquiring individual to make personal contact at the present location of the target individual The central location relays this authorization to the inquiring individual, who then proceeds to establish personal contact with the target individual.

In the embodiment illustrated in FIG. 1, such a negative response ends the procedure. In the alternative, the target individual is afforded the option of denying the inquiring individual access to his/her data files, but nevertheless to specify whether or not to authorize the inquiring individual to establish personal contact.

Once the inquiring individual has initiated personal contact with the target individual, particular embodiments of the invention facilitate further interaction. Thus, particular embodiments provide the inquiring individual with menus containing suggestions for “ice breaking,” such as topics for conversation, witty sayings, jokes and the like, in order to assist the inquiring individual who is shy or lacks self-confidence.

According to other particular embodiments, the data files to which the target individual grants the inquiring individual access can include a listing of the target individual's beverage preferences. The inquiring individual asks the target individual if he/she would like a drink. After a positive response, the inquiring individual accesses the beverage preference file, identifies a beverage preferred by the target individual, and orders the beverage. In very particular embodiments in which the inquiring individual and the target individual initiate contact in an establishment which is also affiliated with the inquiring individual's organization, the inquiring individual is provided, e.g., by the central location, with means, such as a menu, for placing an order for the desired beverage. In such embodiments, the inquiring individual selects the desired beverage, places the order with the establishment (e.g., a bartender, waitress, etc., equipped with an appropriate data receiving device), authorizes payment via a credit card or other payment means, and then proceeds to an appropriate location to obtain the ordered beverage.

In other particular embodiments, the data files to which the target individual grants the inquiring individual access can include a menu of songs or other musical performances preferred by the target individual. By accessing this file, the inquiring individual can determine the extent to which the target individual shares the inquiring individual's tastes in music. Furthermore, in very particular embodiments in which the inquiring individual and the target individual establish contact in a location that plays music, such as a nightclub, discotheque, etc., the inquiring individual can select one or more songs or musical performances and request that the selections be played, e.g., by a DJ, band or other performer at the location. In other very particular embodiments in which the inquiring individual and the target individual are equipped with a headset or other means for reception of audio transmissions, the inquiring individual can select one or more songs or other musical performances from the target individual's list of preferences and submit the selections to the central location. The central location then provides both the inquiring individual and the target individual with an audio stream of the selected song(s) and/or musical performance(s). Thus, the inquiring individual and the target individual are enabled to listen and/or dance to their own selected music, independently of the musical environment (if any) of the location in which they are present.

In related embodiments in which both the inquiring individual and the target individual are equipped with a headset or other means for the reception of audio transmissions, the inquiring individual and the target individual are enabled to communicate with each other via the central location such embodiments are particularly beneficial in noisy environments in which vocal communication is otherwise difficult, such as in nightclubs, concerts, and the like. Such embodiments need not rely on the central location, however. In alternative embodiments, the inquiring individual and the target individual can be equipped with wireless microphone devices or other means for short-range communication. Once the inquiring individual and the target individual agree to establish contact, each provides the other with information (e.g., frequencies, contact protocols, etc.) to enable communication via their wireless microphone devices or other communication means. In very specific embodiments, such communication devices can be provided to the inquiring individual and the target individual by a third party, for example a commercial establishment such as a bar or nightclub that each is patronizing. The devices can be provided to each person upon entry to the establishment and returned by each person when that person leaves the establishment.

Subsequent Interaction

Additional specific embodiments provide suggestions for subsequent activities after the inquiring individual and the target individual establish contact. In one embodiment, the inquiring individual is provided with a menu listing suggestions for a first date with the target individual. The menu can include, in specific embodiments, a listing of restaurants, movie theaters, nightclubs, discotheques, and the like. In more particular embodiments, one or more of the listed options includes a link to a web site maintained by the selected establishment, or enables access by the inquiring individual to another data file pertaining to the selected establishment, by means of which the inquiring individual can obtain additional information concerning the establishment, such as days and hours of operation, screening schedules, pricing information, location of and directions to the establishment, weather conditions at the establishment, etc. In other particular embodiments, selection of a listed option by the inquiring individual accesses one or more advertisements for special packages of goods or services, special discounts, etc. Furthermore, the menu can include listings which are categorized according to price, location, ratings by independent rating services such as the ZAGAT® Guides, MICHELIN® Guides, AAA® (American Automobile Association) Guides, etc.

In further embodiments, the inquiring individual is provided with one or more menus providing suggestions for subsequent dates with the target individual (such menus can also be accessed for first-date purposes if desired by the inquiring individual). Exemplary menus can include “frequent customer” packages that provide increasing benefits to the inquiring individual depending on the number of times a particular establishment is patronized by the inquiring individual and the target individual. Other exemplary menus can include listings of hotels, motels, resort locations and the like which may be of interest to the inquiring individual and/or the target individual. According to very particular embodiments, the inquiring individual is provided with a menu listing hotels and motels. The inquiring individual selects a hotel or motel of interest, and is then enabled, in more specific embodiments, to reserve and authorize payment for a room at the selected hotel or motel. Upon arrival at the hotel or motel, the inquiring individual can pick up his/her key and proceed to the selected room. Furthermore, according to further specific embodiments, the inquiring individual is provided with additional menu selections that enable the inquiring individual to order and arrange payment for flowers, champagne or other beverages, dessert items and the like, as well as other useful items such as condoms, and to request that the selected items by delivered to the selected room prior to the inquiring individual's arrival at the hotel or motel. Upon arrival at the selected room, the requested items are ready for use by the inquiring individual and the target individual.

Additional particular embodiments provide the inquiring individual with a record of previous choices, thus allowing the inquiring individual to avoid undesired repetition.

An inquiring individual and/or a target individual may wish to create a record of one or more contact and/or dates. Thus, according to particular embodiments, the inquiring individual and/or the target individual is provided with a menu option by the central location that enables creation of a contact/dating record. For example, the inquiring individual can create a record for a target individual that includes copies of one or more of the data files to which the target individual granted the inquiring individual access; an evaluation of the inquiring individual's initial contact with the target individual; evaluations of one or more subsequent dates with the target individual; and the like.

After a positive contact, the inquiring individual may desire to send a card, flowers or other gift items to the target individual. However, the target individual, for example due to security concerns, may not yet have provided the inquiring individual with her address or other personal information. Particular embodiments of the inventive method enable the inquiring individual to send one or more items to the target individual without knowing the target individual's address. The central location provides the inquiring individual with a menu including an option for delivery of a gift item to the target individual. When the inquiring individual selects this option, the request is transmitted to the central location, which has the target individual's address.

The central location then transmits an order for the selected gift item to be delivered to the target individual's address, without providing that address to the inquiring individual.

For purposes of security, a target individual may desire to verify the identity of an inquiring individual with whom she/he has established contact. Additional specific embodiments of the inventive method provide the target individual with the option to access one or more data files of the inquiring individual that include information identifying the inquiring individual. For example, the inquiring individual can provide the central location with one or more identification files including a copy of his/her birth certificate, his/her age, his/her educational record, employment history, medical history, records of marriage, divorce, paternity and/or orders for child support, credit report, history of arrests, convictions and/or other incarcerations (e.g., for DUI, sexual assault, etc.), copies of business cards, and the like. Before the target individual authorizes personal contact by the inquiring individual, or at a subsequent time after initial contact is established, the target individual can request access to one or more of the inquiring individual's identification files. Upon inspection of the inquiring individual's identification file(s) if the target individual is satisfied that the inquiring individual's background is acceptable, the target individual can then authorized contact or grant the inquiring individual access to the target individual's files, in a manner similar to that described above. If the target individual is not satisfied, for example if the inquiring individual has not provided the central location with any identification data files, then the target individual can decline to authorize contact by the inquiring individual or take other appropriate action.

In additional specific embodiments, one or more of the inquiring individual's identification data files can include hyperlinks to independent web sites useful for verification of the data included in the files. For example, if one of the inquiring individual's identification files states that the inquiring individual is employed by a specific employer, the file can also include a hyperlink to a web site maintained by the employer. The target Individual can then access the employer's web site to confirm that the inquiring individual is in fact employed by the employer. Alternatively, the central location can offer the target individual a menu including an option of contacting an independent verification service to verify that that data included in the inquiring individual's identification data file(s) is correct. In the event that some or all of the inquiring individual's identification data files are determined to contain inaccurate or fraudulent data, the target individual can then decline to authorize contact by the inquiring individual or take other appropriate action.

In a further refinement of the foregoing embodiments, the inquiring individual provides the central location (or alternatively, an independent database) with one or more files containing biometric data, for example, DNA identification, retinal scans, fingerprints, facial recognition scans etc. Upon establishing contact with the target individual, the inquiring individual then permits the target individual to obtain biometric data from the inquiring individual and compare the data so obtained with the data maintained in the inquiring individual's biometric identification file(s) by the central location or other independent database. Such biometric data can be obtained, in particular embodiments, by a portable unit for scanning fingerprints, retinal patterns or facial features, or by a portable unit for obtaining and analyzing a blood sample (which can include, for example, a biochip or other device). The target individual can then submit the biometric data so obtained to the central location or other independent database for verification. After a positive result, the target individual can authorize further interaction with the inquiring individual. On the other hand, after a negative result, the target individual can decline further interaction with the inquiring individual. In very specific embodiments, the biometric data obtained by the target individual may identify the inquiring individual as being wanted by one or more governmental authorities (i.e., the police, the INS, etc.), in which case the target individual can notify the appropriate authority.

In related particular embodiments, the target individual is equipped with a device for determining whether or not the inquiring individual is under the influence of one or more intoxicants or other controlled substances (e.g., a Breathalyzer unit). The target individual can request that the inquiring individual submit to a test for intoxication prior to accompanying the inquiring individual in a motor vehicle. If the test results indicate that the inquiring individual is intoxicated, the target individual can then decline to accompany the inquiring individual in a motor vehicle, arrange for alternative means of transportation, or take other appropriate action.

Under certain circumstances an inquiring individual may desire to have records created of his/her movements and/or the individuals the inquiring individual attempted to establish contact with or who attempted to establish contact with the inquiring individual. Such a record could, for example, enable the police or family members to attempt to locate him/her in the event the inquiring individual fails to contact family members for a predetermined period of time. Particular embodiments of the inventive method afford the inquiring individual the option of authorizing the central location to create a data file in which the inquiring individual's GPS location and/or contacts are periodically recorded. The inquiring individual is further afforded the option of authorizing one or more third parties to access the location and/or contact files, for example by contacting the central location by means of the Internet, telephonically or by other means.

A variant of the foregoing embodiment affords a third party, for example a parent or guardian of an inquiring individual, to request that the central location create such location and/or contact data files. This parental monitoring function, in specific embodiments, can be performed without the knowledge of the inquiring individual. The monitoring function can also be performed by other parties, such as parole officers.

On the other hand, under certain circumstances the inquiring individual may desire that no such record of his/her movements be made or kept. For example, the inquiring individual may wish to patronize a particular establishment, such as an adult entertainment establishment, without a record being kept of such patronage. More generally, an inquiring individual may not desire to have a continuous recording of his/her movements be created, in order to protect his/her privacy. In specific embodiments of the inventive method, the inquiring individual is afforded the option of disabling the GPS locating function unless and until the inquiring individual instructs the central location to activate the GPS locating function.

In other specific embodiments, the GPS locating function is activated automatically when an inquiring individual patronizes an establishment, such as a nightclub, discotheque, restaurant or the like, which is affiliated with the inquiring individual's organization. The GPS locating function is deactivated when the inquiring individual leaves the establishment. The inquiring individual can also request (for example, through selection of an appropriate menu option) that the central location record, or not record, the inquiring individual's GPS locations while the inquiring individual is present at the establishment, in a manner similar to that described above. In more specific embodiments, the inquiring individual is provided with menu options that allow the inquiring individual to selectively enable or disable recording of the inquiring individual's GPS locations by the central location.

The foregoing embodiments are typically useful at a fixed location, such as a nightclub, bar, restaurant, or other similar establishment, or at a site such as a high school auditorium where social events such as dances are held. However, embodiments of the inventive method are also useful even when the inquiring individual and the target individual are not in a fixed location, but rather are each in a moving location such as an automobile, boat, or the like. Thus, in particular embodiments, an inquiring individual driving, for example, an automobile visually identifies a target individual driving another automobile and desires to establish contact with the target individual. If the target individual is a member of the inquiring individual's organization, then the inquiring individual is enabled to transmit a request to the central location to initiate contact by, for example, providing the central location with an identification number, license plate number or other identifying indicium which the target individual has previously provided to the central location and has also placed in a location that is visible to the inquiring individual. In an alternative embodiment, the inquiring individual determines the location of the target individual by GPS means, in a manner similar to that previously described. Once the target individual has been identified, by identifying indicium or by GPS location, the inquiring individual is then afforded the option of attempting to establish contact with the target individual. In more specific embodiments, both the inquiring individual's vehicle and the target individual's vehicle are equipped with means for transmitting and receiving at least audio information via the Internet. The inquiring individual transmits to the central location a request to contact the target individual, preferably by audio means such as a telephonic menu. The target individual then receives an appropriate notification from the central location indicating that the inquiring individual wishes to establish contact with the target individual.

In specific embodiments, the central location provides an audio and/or textual message, rather than a visual message, in order to ensure that the target individual does not become distracted while driving. In very specific embodiments, the target inquiring individual can be advised that visual information is available once the vehicle is parked and no longer moving. The target individual can then stop the vehicle and access one or more of the use's data files in a manner similar to that described above. Alternatively, the target individual is afforded the option of forwarding the inquiring individual's data files to a third party for visual evaluation by the third party. The third party can then provide the target individual with a verbal report on the inquiring individual's appearance as well as on the content of other of the inquiring individual's data files. If the target individual is interested in being contacted by the inquiring individual, then the target individual can proceed in a manner similar to that described above, preferably by use of non-visual means such as providing responses to a telephone menu.

Further embodiments of the inventive method are useful when the inquiring individual and the target individual are in separate locations and are not in direct visual contact. In these embodiments, the inquiring individual first accesses a third party (an individual, a commercial establishment, etc.) over the Internet. The third party is in possession of a camera or other device capable of transmitting a video stream over the Internet. The inquiring individual then makes use of the third party's camera to identify a target individual of interest in a manner similar to that described above. If the target individual is a member of the inquiring individual's organization, then the inquiring individual can attempt to establish contact remotely via the third party's camera. In particular embodiments, the third party is compensated for affording the inquiring individual the use of the third party's camera. In other particular embodiments, particularly useful when the inquiring individual and the target individual are located in different countries and speak different languages, the third party functions as a translator. Alternatively, the inquiring individual and/or the target individual can access independent translators to facilitate communication.

The foregoing particular embodiments make use of the central location to relay data and facilitate communication between the inquiring individual and the target individual. Alternative embodiments allow the inquiring individual to establish contact with the target individual by means of dedicated devices without use of the central location. In such embodiments, the inquiring individual and the target individual patronize an establishment, such as a nightclub, bar, or the like, which provides each of them with a paging device that preferably includes ranging and locating means. The paging device, in very particular embodiments, also includes means for downloading data supplied by the inquiring individual and/or target individual, such as a CD-ROM drive, and means for transmitting such data. The inquiring individual visually identifies a target individual of interest, determines the relative location of the target individual using the ranging and locating means, and, using the paging device, transmits a signal to the target individual's paging device. Preferably, the signal includes an identifying indicium, such as a code number or an identified frequency specific to the inquiring individual's paging device, to ensure that any data transmitted by the target individual is transmitted only to the inquiring individual. If the target individual desires to establish contact with the inquiring individual, she/he transmits a signal to the inquiring individual authorizing the inquiring individual to transmit one or more data files previously downloaded into the paging device. The target individual then reviews the transmitted data and determines whether or not to continue with the communication, in a manner similar to that described above.

Additional embodiments of the inventive method include both GPS location and the use of separate paging devices. In such embodiments, the inquiring individual identifies a target individual by determining his/her GPS location, as described above, and initiates contact with the target individual over the Internet. Once initial contact has been established, however, the inquiring individual and the target individual exchange data via paging devices, rather than through the central location.

A system for implementing a remote dating method according to the invention preferably includes at least the following: a ranging element; a location-determining element; and an element for transmitting information to a central location and receiving information from the central location. Various of these elements can be combined or integrated into a single unit.

A first specified embodiment of the inventive apparatus includes an ocular ranging device, in particular a cross-hairs element and an element that measures the positions of the inquiring individual's eyes and uses these measurements to determine the distance to the target (e.g., by triangulation); an integrated data processing and transceiving unit that includes (a) a GPS location device; (b) a wide-area network accessing element including (12) a processor provided with appropriate software and (2) a modem; (c) a communication device, such as a cellular telephonic device, connected to the processor via the modem; (d) an input device such as a keypad; and (e) a display element, in particular including an HUD, and also preferably including an earphone or other element for providing audio information. The ranging element, the HUD and the earphone can be part of a headset which is in turn connected to the wide-area network accessing element.

Referring to FIGS. 2A-C, an embodiment of a system for implementing a remote dating method of the invention includes a headset 10 having a frame 12 and ear pieces 14. Affixed to frame 12 are earphone 16, HUD 18 having a cross-hairs element 20, sensors 22 for determining the positions of the eyes of an inquiring individual wearing the headset 10, and direction determining element 23 (such as an electronic compass). Earphone 16, HUD 18, sensors 22 and direction determination element 23 are in electrical communication via cord 24 with integrated processing/transceiving unit 26, which preferably is carried or worn by the inquiring individual. Unit 26 includes a GPS location determination element 28 (in particular embodiments in electrical communication with HUD 18 to enable display of GPS coordinates on the HUD), a processing element 30, preferably including a microprocessor and appropriate software and preferably in electrical communication with HUD 18 to enable display of data files and other information, a communication element 32 such as a cellular telephonic element, a keypad 34 in electrical connection with processing element 30 and communication element 32, and optionally a trackball 36 for positioning a cursor (not shown) displayed on HUD 18 to enable the inquiring individual to select one or more menu items viewed on the HUD.

Preferably, both the inquiring individual and the target individual are equipped with devices 10.

In practicing a method of the invention using device 10, an inquiring individual sights a target individual using the cross-hairs element 20. Sensors 22 determine the position of the inquiring individual's eyes while the inquiring individual is observing the target individual and provide the ocular position information to processing element 30. Element 23 determines the orientation of the inquiring individual. Processing element 30 then determines the distance from the inquiring individual to the target individual. GPS determination element 28 provides the inquiring individual's location. The inquiring individual's location and orientation, combined with the distance from the inquiring individual to the target individual, then are input to processing element 30 to determine the location of the target individual. This location is transmitted to the remote dating service's central location (not shown) using communication element 32.

The central location then contacts the target individual, who in specific embodiments is also using an apparatus 10. The signal from the central location is displayed on the target individual's HUD and/or provided via earphone 16. In specific embodiments, the target individual provides a positive or negative response using keyboard 34. In other specific embodiments, a menu is displayed on HUD 18, and the target individual selects the appropriate response using keyboard 34 and/or trackball 36. Following a positive response, access to the inquiring individual's data file(s) is provided to the target individual, in specific embodiments via an appropriate menu displayed on HUD 18. The target individual can specify one or more of the inquiring individual's data files of interest, again using keyboard 34 and/or trackball 36. Data files containing text, photographic and/or video information are displayed on HUD 18, while audio information is conveyed to the target individual via earphone 16. Subsequently, the target individual provides further negative or positive responses to the inquiring individual using keyboard 34 and/or trackball 36 in a manner similar to that previously described.

Referring to FIG. 3, an alternative headset 40 includes an infrared pointer device 42 in place of the sensors 22 of the previous embodiment. Infrared pointer device 42 emits an infrared beam that is reflected off the target individual and provides a direct measurement of the distance between the target individual and the inquiring individual. This measurement, together with the orientation of the inquiring individual as determined by element 23, is provided to processing element and used to determine the location of the target individual in a manner similar to that discussed above.

The inventive method has been described primarily in the context of facilitating social interactions. However, alternative embodiments of the invention are more generally applicable to situations that rely on the location of a target individual and the acquisition of information pertaining to the target individual. Thus for example, an alternative embodiment of the inventive method is useful as a security system. In such an embodiment, the inquiring individual identifies (visually or by other means) a target individual, for example in a public place such as a bus stop, restaurant, market or other location. After the target individual is identified, his/her location is determined and the location is provided to the central location, as described previously. In specific embodiments, the target individual bears indicia indicating membership in a particular organization, while in other embodiments, recognition software is utilized in order to identify the target individual. The central location then searches for one or more data files pertaining to the target individual. In specific embodiments, the central location searches for one or more data files that contain information indicating whether or not the target individual is authorized to be present in his/her present location, or is prohibited from being present in such location; whether or not the target individual is a known member of a criminal or terrorist organization or is otherwise wanted by a government authority; or other information.

Thus, for example, a security officer or concerned citizen can identify a target individual and attempt to determine whether the target individual is wanted by a government authority or otherwise potentially constitutes a threat to public security.

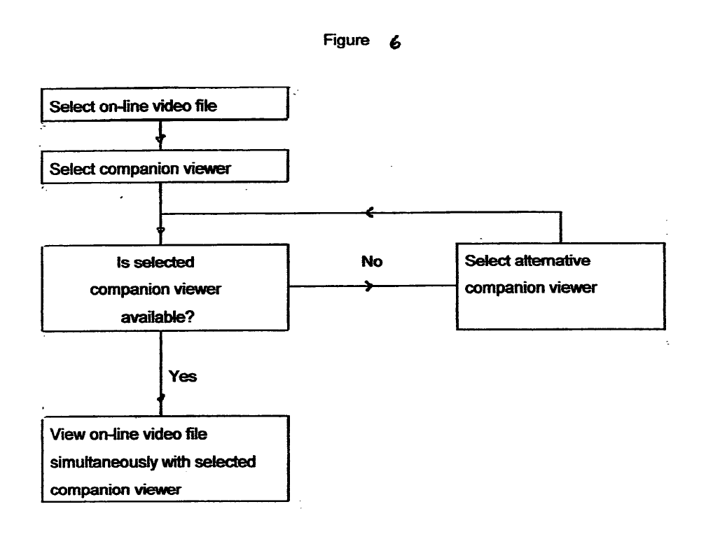

According to additional embodiments of the inventive method, an inquiring individual identifies (visually or by other means) a target individual and establishes contact as described herein. After establishing contact, the inquiring individual invites the target individual to an on-line video viewing, as described in U.S. patent application Ser. No. 12/070,715, incorporated herein by reference. An example of such post-contact on-line video viewing is illustrated in FIG. 6 (corresponding to FIG. 1 of the '715 application).

In particular embodiments, a remote dating organization to which the inquiring individual and the target individual belong also promotes simultaneous on-line viewing of video files by two or more of its members, as described in the '715 application. Thus, the inquiring individual simply selects the target individual as his/her companion viewer. In alternative embodiments, the inquiring individual is a member of a separate organization that promotes simultaneous on-line viewing of video files by two or more of its members. The inquiring individual invites the target individual to join the latter organization and submit her/his name for listing with some or all of the available video files offered for viewing by the latter organization. Once the target individual does so, the inquiring individual then selects the target individual as his/her companion viewer for viewing a selected video file. In various specific embodiments, the inquiring individual first proposes a video file for viewing, then selects that video file at the time he/she selects the target individual as the companion viewer. In other specific embodiments, the target individual suggests the video file for viewing.

Co-ordinated on-line video viewing by the inquiring and target individuals affords additional advantages. A target individual may be receptive to further interaction with the inquiring individual, yet be reluctant initially to do so in person. Co-ordinated on-line video viewing allows the target individual to share a video-viewing experience with the inquiring individual without the necessity for in-person interaction (i.e., go on a “virtual movie date”), affording the target individual an added measure of security until the target individual becomes comfortable with further interaction with the inquiring individual, and also affords additional time for background research or other investigations of the inquiring individual by the target individual.

Furthermore, in the event that the target individual (or the inquiring individual) is actually a cast member, director, writer, reviewer, etc. of an on-line video, embodiments of the invention that facilitate co-ordinated on-line viewing provide an additional desirable option for interaction between the inquiring and target individuals.

What is claimed is:

1. A method of establishing personal contact between an inquiring individual and a target individual, the inquiring and target individuals being members of an organization, the method comprising the steps of:
a) identifying a target individual of interest to an inquiring individual, wherein the inquiring individual identifies the target individual by personally targeting the target individual,
b) determining the location of the target individual and providing the location of the target individual to a central location,
c) providing the target individual with a message that the inquiring individual is interested in establishing personal contact with the target individual,
d) providing the inquiring individual with authorization to establish personal contact with the target individual when the target individual provides a positive response to the central location,
e) inviting the target individual to view an on-line video file with the inquiring individual,
f) selecting an on-line video file for co-ordinated on-line video viewing by the inquiring individual and the target individual, and
g) viewing at least a portion of the selected on-line video file, the viewing being performed simultaneously by the inquiring individual and the target individual.

2. The method of claim 1 wherein in step (a) the inquiring individual visually identifies the target individual.

3. The method of claim 2 wherein the target individual bears indicia identifying the target individual as a member of an organization in which the inquiring individual is a member.

4. The method of claim 1 wherein in step (b) the location and direction of the target individual are determined with respect to the inquiring individual.

5. The method of claim 4 wherein the distance between the inquiring individual and the target individual is determined using a ranging device.

6. The method of claim 4 wherein the GPS (Global Positioning System) coordinates of the target individual and of the inquiring individual are determined.

7. The method of claim 1 wherein in step (b) the central location is maintained by an organization in which the inquiring individual is a member.

8. The method of claim 7 the inquiring and target individuals are members of the organization.

9. The method of claim 1 wherein the location of the target individual is provided to the central location via a network.

10. The method of claim 1 wherein in step (c) the message is provided to the target individual via a network.

11. The method of claim 10 wherein the message is provided by a central location maintained by an organization in which the inquiring individual and the target individual are members.

12. The method of claim 10 wherein the message is provided by a central location maintained by an organization in which the inquiring individual is a member via a second central location maintained by an affiliated organization in which the target individual is a member.

13. The method of claim 1 wherein in step (c) the target individual is further advised of the relative location of the inquiring individual.

14. The method of claim 1 wherein after step (c) the target individual requests access to information pertaining to the inquiring individual.

15. The method of claim 1 wherein after step (c) the target individual authorizes access by the inquiring individual to information pertaining to the target individual.

16. The method of claim 15 wherein the information pertaining to the target individual is organized into a plurality of disclosure levels and wherein the target individual specifies the disclosure level to which access by the inquiring individual is authorized.

17. The method of claim 1 wherein the organization in which the inquiring individual and the target individual are members promotes simultaneous on-line viewing of video files by two or more of its members.

18. The method of claim 5 wherein the ranging device is selected from the group consisting of a device having an element that determines the range to a target based on the eye positions of the inquiring individual, an infrared device, and an ultrasonic device.

19. The method of claim 1 wherein in step (b) the location of the target individual is determined using an apparatus comprising .
(i) an ocular ranging device comprising a cross-hairs element and an element that measures the positions of the inquiring individual's eyes and uses the positions thus measured to determine the distance to the target individual,
(ii) an integrated data processing and transceiving unit comprising
(a) a GPS location device,
(b) a wide-area network accessing element comprising a processor,
(c) a communication device connected to the processor,
(d) an input device, and
(e) a display element comprising an HUD (heads-up display).

20. The method of claim 19 wherein the integrated data processing and transceiving unit further comprises an earphone.

21. The method of claim 20 wherein the ranging element, the HUD and the earphone are incorporated into a headset, the headset being connected to the wide-area network accessing element.

22. The method of claim 1 further comprising the step of transmitting an instruction from the inquiring individual to the computer on the network to deliver a gift item to an address of the target individual, wherein the inquiring individual does not know the address of the target individual and wherein the computer on the network has been provided with the address of the target individual.

23. The method of claim 1 wherein the inquiring individual and the targeting individual are equipped with means for the reception of audio transmissions, and wherein subsequent to establishment of personal contact with the target individual the inquiring individual and the target individual are enabled to verbally communicate.

24. The method of claim 23 wherein verbal communication between the inquiring individual and the target individual is carried out via the computer on the network.

25. The method of claim 23 wherein the inquiring individual and the target individual are provided with short-range communication devices and verbal communication between the inquiring individual and the target individual is carried out via the short-range communication devices.

26. The method of claim 25 wherein the short-range communication devices are provided to the inquiring individual and the target individual by an establishment upon entry into the establishment.

27. The method of claim 1 wherein prior to step d) the identity of the inquiring individual is verified by the computer on the network.

28. The method of claim 1 wherein the target individual is afforded the choice to disable location determination.

29. The method of claim 6 wherein the inquiring individual is present at an establishment, and wherein GPS coordinate determination is automatically activated upon entry into the establishment.

30. The method of claim 1 wherein the inquiring individual and the target individual are in locations in relative movement to each other.

31. The method of claim 30 wherein the inquiring individual and the target individual are in different moving vehicles.

32. The method of claim 30 wherein the computer on the network provides a non-visual message to the target individual.

33. A method of establishing contact between an inquiring individual and a target individual, the inquiring and target individuals being members of an organization, the inquiring individual and the target individual being at different physical locations, the method comprising the steps of:
a) identifying a target individual of interest to an inquiring individual, wherein the inquiring individual identifies the target individual via a third party who is present at the physical location of the target individual,
b) determining the location of the target individual and providing the location of the target individual to a computer on a network,
c) providing a message from the computer on the network to the target individual that the inquiring individual is interested in establishing personal contact with the target individual,
d) providing authorization from the computer on the network to the inquiring individual with authorization to establish personal contact with the target individual after the target individual provides a positive response to the computer on the network,
e) inviting the target individual to view an on-line video file with the inquiring individual,
f) selecting an on-line video file for co-ordinated on-line video viewing by the inquiring individual and the target individual, and
g) viewing at least a portion of the selected on-line video file, the viewing being performed simultaneously by the inquiring individual and the target individual.

34. The method of claim 33 wherein the third party provides a video stream to the inquiring individual enabling the inquiring individual to identify the target individual.

35. The method of claim 33 wherein the inquiring individual and the target individual do not speak a common language, and wherein the third party acts functions as a translator between the inquiring individual and the target individual.

36. A method of establishing personal contact between an inquiring individual and a target individual, the inquiring and target individuals being members of an organization, the method comprising the steps of:
a) identifying a target individual of interest to an inquiring individual, wherein the inquiring individual identifies the target individual by personally targeting the target individual,
b) determining the location of the target individual and providing the location of the target individual to a computer on a network,
c) providing a message from the computer on the network to the target individual that the inquiring individual is interested in establishing personal contact with the target individual,
d) providing authorization from the computer on the network to the inquiring individual with authorization to establish personal contact with the target individual after the target individual provides a positive response to the computer on the network, and
e) providing information to the inquiring individual from the computer on the network pertaining to at least one activity subsequent to establishment of personal contact with the target individual.

37. A method of establishing contact between an inquiring individual and a target individual, the inquiring and target individuals being members of an organization, the inquiring individual and the target individual being at different physical locations, the method comprising the steps of:
a) identifying a target individual of interest to an inquiring individual, wherein the inquiring individual identifies the target individual via a third party who is present at the physical location of the target individual,
b) determining the location of the target individual and providing the location of the target individual to a computer on a network,
c) providing a message from the computer on the network to the target individual that the inquiring individual is interested in establishing personal contact with the target individual, and
d) providing authorization from the computer on the network to the inquiring individual with authorization to establish personal contact with the target individual after the target individual provides a positive response to the computer on the network.
